(19) United States
(12) Patent Application Publication
(10) Pub. No.: US 2019/0387706 A1
(43) Pub. Date: Dec. 26, 2019

(54) ADJUSTABLE, PORTABLE STAIRS

(71) Applicant: ProTrav, LLC, Sheridan, WY (US)

(72) Inventor: Christopher K. BACHMAN, Park City, UT (US)

(73) Assignee: ProTrav, LLC, Sheridan, WY (US)

(21) Appl. No.: 16/452,347

(22) Filed: Jun. 25, 2019

Related U.S. Application Data
(60) Provisional application No. 62/689,762, filed on Jun. 25, 2018.

(51) Int. Cl. A01K 1/035; E06C 1/00; E06C 1/28; E06C 1/38; E04F 11/06

(52) U.S. Cl. CPC A01K 1/035; E06C 1/005; E04F 11/06; E06C 1/38; E06C 1/28

(57) ABSTRACT

Apparatuses and systems are disclosed for portable stairs. In one embodiment, a support structure extends from a lower level to an upper level. In a certain embodiment, a plurality of steps are coupled to the support structure. In a further embodiment, an apparatus includes means for independent, per-step adjustment of step positions relative to the support structure.

### CROSS-REFERENCES TO RELATED APPLICATIONS

This application claims the benefit of U.S. Provisional Patent Application No. 62/689,762 entitled “ADJUSTABLE, PORTABLE, PET STAIRS” and filed on Jun. 25, 2018 for Christopher K. Bachman, which is incorporated herein by reference.

### FIELD

This invention relates to stairs and more particularly relates to adjustable, portable stairs.

### BACKGROUND

Portable stairs may be adjustable to different heights. Some types of portable stairs use parallelogram-shaped linkages to keep steps level, when the height of the portable staircase is adjusted. With such linkages, changing the height of the top step changes the tread to tread rise and the front edge to front edge tread depth between each pair of adjacent steps, in a uniform manner. The result may be a high tread to tread rise with a short front edge to front edge tread depth when the stairs are adjusted higher, or a low tread to tread rise with a long front edge to front edge tread depth when the stairs are adjusted lower. Some combinations of tread to tread rise and front edge to front edge tread depth may not suitably accommodate the physiology of users. For example, portable stairs used for pets may accommodate human physiology better than the physiology of dogs or other pets.

### SUMMARY

A portable stair apparatus is disclosed. In one embodiment, a support structure extends from a lower level to an upper level. In a certain embodiment, a plurality of steps are coupled to the support structure. In a further embodiment, an apparatus includes means for independent, per-step adjustment of step positions relative to the support structure.

In one embodiment, the support structure includes one or more risers extending diagonally from the lower level to the upper level. In a further embodiment, the support structure includes a base coupled to the one or more risers. In one embodiment, an apparatus includes means for adjusting an angle of the one or more risers.

In one embodiment, the steps each include a tread area and a tongue area narrower than the tread area. In a further embodiment, a riser includes one or more openings to admit the tongue areas of the steps. In one embodiment, the steps each include one or more prongs. In a further embodiment, a riser includes a plurality of holes to admit the prongs.

In one embodiment, a means for independent, per-step adjustment of step positions includes a plurality of step attachment points provided by one or more risers. In a certain embodiment, one or more riser extensions are capable of extending from one or more risers to increase a height of the support structure.

In some embodiments, the means for independent, per-step adjustment of step positions permits adjustment of step angle, step rise, horizontal step position, or combinations thereof. In some embodiments, an apparatus includes a set of removable steps of varying sizes, and the plurality of steps coupled to the support structure are selected from the set of removable steps. In some embodiments, the plurality of steps are of non-uniform size. In some embodiments, vertical distances between pairs of steps are non-uniform.

In some embodiments, the support structure includes slots at a plurality of step heights, for admitting the steps. In some embodiments, one or more landings are coupled to the support structure. In some embodiments, the plurality of steps ascends in a first direction from the lower level to a landing, and ascends in a second direction, different from the first direction, from the landing to the upper level. In some embodiments, a landing extends onto a surface of a piece of furniture, at the upper level. In some embodiments, an extension member extends from the support structure or from a step, and is insertable in a horizontal gap in a piece of furniture to stabilize the apparatus.

Portable stair systems are disclosed. In one embodiment, a support structure is configured to extend from a lower level to an upper level. In a certain embodiment, a plurality of steps are selectively attachable to the support structure at a plurality of adjustable step heights.

In some embodiments, the support structure includes a riser configured to extend diagonally from the lower level to the upper level, and one or more legs for supporting the riser. In a further embodiment, a position of the legs is adjustable for adjusting the angle and height of the riser.

A portable stair apparatus, in another embodiment, includes a support structure extending from a lower level to an upper level. In some embodiments, a support structure includes a base, a riser coupled to the base and extending diagonally from the lower level to the upper level, and one or more legs for supporting the riser. In some embodiments, a position of the legs is adjustable for adjusting the angle and height of the riser. In certain embodiments, a plurality of step attachment points are formed in the riser for attaching steps at a plurality of adjustable step heights. In further embodiment, a plurality of steps are coupled to the support structure. The steps may each include a tread area and a tongue area narrower than the tread area, and the step attachment points may include one or more openings to admit the tongue areas of the steps.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating one embodiment of a portable stair apparatus;

FIG. 2 is a side view further illustrating the apparatus of FIG. 1;

FIG. 3 is a front view further illustrating the apparatus of FIG. 1;

FIG. 4 is a side view illustrating one embodiment a step and dowels for use with the apparatus of FIG. 1;

FIG. 5 is a perspective view illustrating another embodiment of a portable stair apparatus;

FIG. 6 is a side view illustrating one embodiment of a step attached to the apparatus of FIG. 5;

FIG. 7 is a perspective view illustrating another embodiment of a portable stair apparatus;

FIG. 8 is a side view further illustrating the apparatus of FIG. 8;

FIG. 9 is a perspective view illustrating one embodiment of a means for adjusting a riser angle;

FIG. 10 is a side view illustrating another embodiment of a means for adjusting a riser angle;

FIG. 11 is a side view illustrating another embodiment of a means for adjusting a riser angle;

FIG. 12 is a side view illustrating one embodiment of a shock absorber for a riser;

FIG. 13 is a side view illustrating another embodiment of a portable stair apparatus;

FIG. 14 is a top view illustrating one embodiment of a step with adjustable horizontal step position;

FIG. 15 is a side view illustrating another embodiment of a step with adjustable horizontal step position;

FIG. 16 is a side view illustrating another embodiment of a step with adjustable horizontal step position;

FIG. 17 is a perspective view illustrating another embodiment of a portable stair apparatus;

FIG. 18 is a perspective view illustrating a one embodiment of a step for use with the apparatus of FIG. 17;

FIG. 19 is a side view illustrating another embodiment of a portable stair apparatus;

FIG. 20 is a perspective view illustrating one embodiment of a dowel with holes, for use with the apparatus of FIG. 19;

FIG. 21 is a side view illustrating steps coupled to dowels with holes, in one embodiment;

FIG. 22 is a side view illustrating another embodiment of a portable stair apparatus;

FIG. 23 is a front view further illustrating the apparatus of FIG. 22;

FIG. 24 is a front view illustrating another embodiment of a portable stair apparatus;

FIG. 25 is a side view illustrating a step attached to a riser in an embodiment of the apparatus of FIG. 24;

FIG. 26 is a side view illustrating another embodiment of a riser for use with the apparatus of FIG. 24;

FIG. 27 is a front view illustrating a step attached to a riser in an embodiment of the apparatus of FIG. 24;

FIG. 28 is a side view illustrating another embodiment of a portable stair apparatus;

FIG. 29 is a front view further illustrating the apparatus of FIG. 28;

FIG. 30 is a side view further illustrating the apparatus of FIG. 28;

FIG. 31 is a side view illustrating a detail of steps coupled to risers in the apparatus of FIG. 28;

FIG. 32 is a perspective view illustrating another embodiment of a portable stair apparatus;

FIG. 33 is a side view further illustrating the apparatus of FIG. 32;

FIG. 34 is a perspective view illustrating the apparatus of FIG. 32 with a landing and an extension member;

FIG. 35 is a side view further illustrating the landing and extension member of FIG. 34;

FIG. 36 is a side view illustrating a riser angle adjustment and a step angle adjustment for a portable stair apparatus, in one embodiment;

FIG. 37 is a side view further illustrating the riser angle adjustment and step angle adjustment of FIG. 36,

FIG. 38 is a side view illustrating a step height adjustment with the step angle adjustment of FIG. 36,

FIG. 39 is a front view illustrating another embodiment of a portable stair apparatus;

FIG. 40 is a side view further illustrating the apparatus of FIG. 39;

FIG. 41 is a side view illustrating another embodiment of a portable stair apparatus;

FIG. 42 is a front view illustrating detail of a step for use with the apparatus of FIG. 41;

FIG. 43 is a side view illustrating another embodiment of a portable stair apparatus;

FIG. 44 is a front view illustrating a step from the apparatus of FIG. 43;

FIG. 45 is a side view illustrating a step from the apparatus of FIG. 43;

FIG. 46 is a top view illustrating a base from the apparatus of FIG. 43;

FIG. 47 is a side view illustrating a step coupled to a riser, in one embodiment;

FIG. 48 is a side view illustrating another embodiment of a portable stair apparatus

FIG. 49 is a top view further illustrating the apparatus of FIG. 48;

FIG. 50 is a side view illustrating one embodiment of a step with walls; and

FIG. 51 is a top view illustrating the step of FIG. 50 and walls removed from the step.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are included to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Applicant recognizes that a need exists for adjustable stairs for dogs or other pets. Portable stairs may be used to allow dogs or other pets to climb into a car or truck, onto a couch or bed, or the like. However, traditional human stairs, and certain dog stairs derived from them, are often designed for human needs and physiology, not for canine need physiology. Canines have an entirely different set of ergonomic needs and design parameters which have been largely ignored by makers of dog stairs.

Dogs with physical handicaps such as injury, rehab, long back, short legs, or the like may especially benefit from custom stairs which address their specific need. Some dog stairs may attempt to accommodate these specific needs by including ramps. However, although dog paws do not work well with ramps beyond a very slight incline, some ramps may disregard this factor and provide inclines of 45 degrees or more. Large inclines cause additional pain and discomfort for the dog attempting to use them.

Additionally, as described above, adjustable-height stairs may have limited adjustability, resulting in large rises over short front edge to front edge tread depths for steep or high height adjustments, or in small rises over long front edge to front edge tread depths for shallow or short height adjustments. The combination of available heights and rises may be designed based on human needs, not based on pet needs. Overall, most pets expected to use stairs will benefit from stairs customized and/or adjusted to their needs.

In general, in various embodiments, a portable stair apparatus may include a support structure extending from a lower level to an upper level, a plurality of steps coupled to the support structure, and means for independent, per-step adjustment of step positions relative to the support structure. A portable stair system may include a support structure and a plurality of steps that are selectively attachable to the support structure at a plurality of adjustable step heights. For example, a system may be sold disassembled or as a flat pack, and may be assembled to form a portable stair apparatus. Providing for independent, per-step adjustment of step positions relative to the support structure may, in various embodiments, permit a user to adjust or customize portable stairs to pet needs rather than to human needs. Similarly, steps that are selectively attachable at adjustable step heights, may in various embodiments, may be independently adjusted to accommodate pet needs.

In the following description, several different embodiments of portable pet stairs are disclosed with reference to various Figures. The depicted and described embodiments are included for illustrative and non-limiting purposes. Additionally, aspects or implementations of different embodiments may be interchangeable. For example, a riser described with reference to one embodiment may be usable with steps described with reference to another embodiment. A person skilled in the relevant art will recognize when a structure described for use with one embodiment of a portable stair apparatus is also suitable for use with another embodiment of a portable stair apparatus.

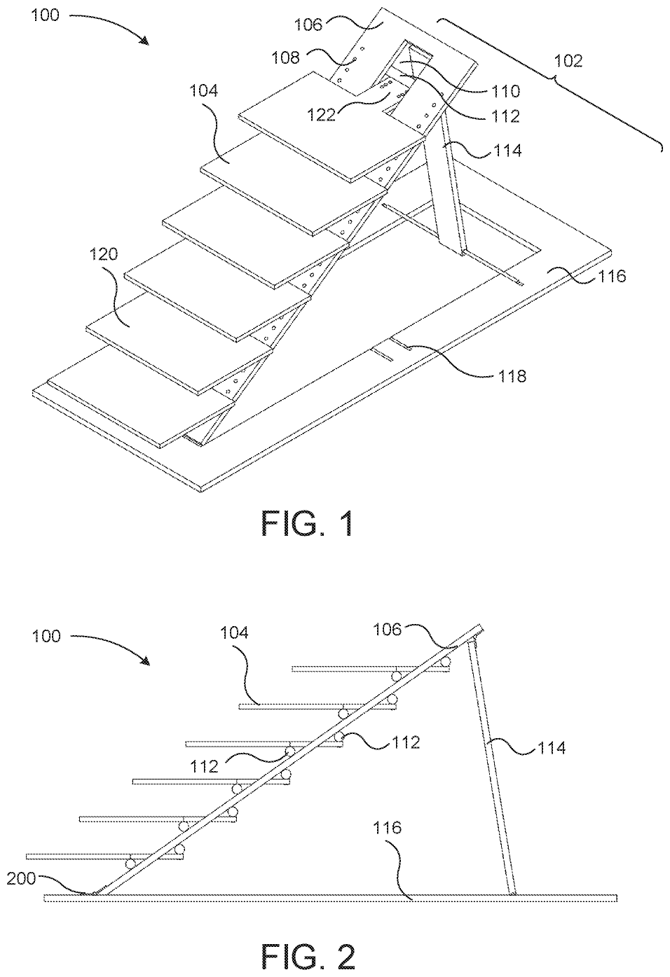

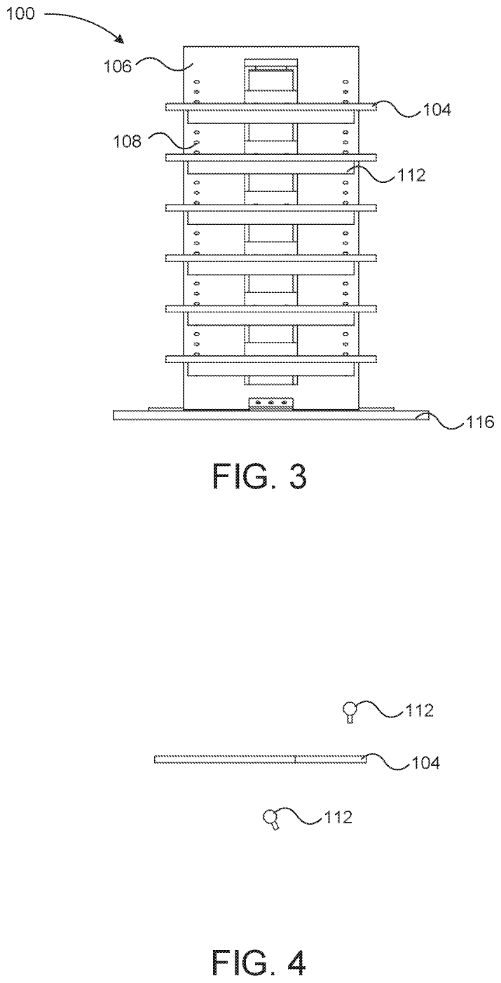

FIGS. 1, 2, and 3 depict a perspective view, a side view, and a front view of a portable stair apparatus 100, in one embodiment. In the depicted embodiment, the portable stair apparatus includes a support structure 102, a plurality of steps 104, and means for independent, per-step adjustment of step positions relative to the support structure 102.

A support structure 102, in various embodiments, may be any structure that extends from a lower level to an upper level. In further embodiments, the support structure may support steps 104 usable by a pet (or another animal, or a human) to ascend from a position at or near the lower level to a position at or near the upper level, or to descend from a position at or near the upper level to a position at or near the lower level. In some embodiments, a portable stair apparatus 100 or system may be disassembled, and the support structure 102 may not extend from the lower level to the upper level in the disassembled state, but may be configured to extend from the lower level to the upper level when assembled together with steps 104.

In the depicted embodiment, the support structure 102 includes a riser 106 extending diagonally from the lower level to the upper level. Although the term “riser” is sometimes used in other contexts to refer to a vertical portion between treads of two stair steps, the term is used herein to refer to a member that supports or is coupled to multiple steps. In the depicted embodiment, steps 104 are coupled to a single riser 106. In another embodiment, steps 104 may be coupled to one or more risers. For example, instead of providing a riser 106 underneath steps 104, a portable stair apparatus may include a pair of risers at opposite sides of the steps to support the steps from the side, triple risers supporting the steps from the sides and from underneath, or the like.

In the depicted embodiment, the support structure 102 includes a base 116 coupled to the riser 106. In another embodiment with multiple risers, a base may be coupled to one or more of the risers. A base 116 may provide support or stability for a portable stair apparatus 100. In another embodiment, a support structure 102 may not include a base 116. For example, a riser 106 may rest with a lower end on the floor and an upper end on a couch or bed.

In some embodiments, an angle of the riser 106 (or of another component of a support structure) may be fixed. In certain other embodiments, however, a support structure 102 may include means for adjusting an angle of the riser 106. Various structures are described herein with reference to FIGS. 1-4 and other Figures, for adjusting an angle of a riser 106. For example, in the depicted embodiment, a leg 114 supports the riser 106, and the angle (and height) of the riser is adjustable by adjusting the position of the leg to engage with different slots 118 in the base 116. In another embodiment, a plurality of legs may support a riser 106, and adjusting the position of the multiple legs may adjust the angle of the riser 106. A hinge 200 (depicted in FIG. 2) couples the bottom end of the riser 106 to the base 116. Thus, means for adjusting an angle of the riser 106 may include the leg 114, the slots 118, and/or the hinge 200. Further means for adjusting an angle of a riser 106 are disclosed with reference to subsequent Figures.

The steps 104, in the depicted embodiment, are coupled to the support structure 102. In the depicted embodiment, the steps each include a tread area 120 and a tongue area 122. The tongue area 122 is narrower than the tread area 120. An opening 110 in the riser 106 admits the tongue areas 122 of the steps. Although a single opening 110 is depicted, a riser 106 may include multiple openings to admit tongue areas of steps 104, such as multiple parallel vertical slots for steps 104 with multiple tongues 122, parallel horizontal slots at different step heights, or the like.

With tongue areas 122 of the steps 104 inserted through the opening 110, the steps 104 may be coupled to the riser 106 (and to the support structure 102 as a whole) using dowels 112. As seen in FIG. 2, dowels 112 positioned underneath the front of a step 104 and above the back of the step 104 may secure the step in place and support the step when a pet steps on the tread area 120 of the step. FIG. 4 depicts a side view of a step 104, and dowels 112 for use with the apparatus of FIG. 1. Pins extending from the dowels 112 may engage holes 108 at a plurality of step attachment points provided by the riser 106, as depicted in FIGS. 1-3.

Step attachment points, in various embodiments, may refer to locations provided by one or more risers 106 or a support structure for affixing steps 104 in place at various heights. In certain embodiments, steps 104 may be detachable from the support structure 102 and may be selectively attachable to the support structure 102 at a plurality of adjustable step heights. For example, steps 104 may be attached at step attachment points selected by a user, at various heights. In one embodiment, step attachment points may be discrete locations. For example, in the depicted embodiment, each pair of holes 108 corresponds to one attachment point. In another embodiment, step attachment points may be continuous locations. For example, in some embodiments, steps 104 may be slidable along a riser 106 or other support structure, and may be clamped in place at attachment points that form a continuum rather than a discrete set.

Means are provided for independent, per-step adjustment of step positions relative to the support structure. Adjusting the position of a step independent of other steps may include adjusting the height or rise of the step, the angle of the step, the horizontal position of the step (e.g., including the horizontal distance of the front edge of the step from the front edge of another step), or the like. Thus, in various embodiments, a means for independent, per-step adjustment of step positions may permit adjustment of step angle, step rise, horizontal step position, or combinations thereof. For example, adjustment of horizontal step position for multiple steps may allow a user to adjust the overall slope of the steps 104, or the local slope between adjacent steps. Various structures are described herein with reference to FIG. 1-4 and other Figures, for independently adjusting positions of steps on a per-step basis. For example, in the depicted embodiment, the step angle and step height of a step 104 may be adjusted by repositioning dowels 112 to engage different holes 108 at different step attachment points. More generally, in certain embodiments, a means for independent, per-step adjustment of step positions may include a plurality of step attachment points provided by the one or more risers 106 at various heights.

Additionally, in the depicted embodiment, the horizontal step position of a step 104 may be adjusted by moving the tongue area 122 of a step 104 back and forth within the opening 110. (In certain embodiments, dowels or pins may engage holes in the tongue area 122 or elsewhere in a step 104 to lock the step 104 in the selected horizontal position place while the apparatus 100 is in use). Further means for independent, per-step adjustment of step positions are disclosed with reference to subsequent Figures.

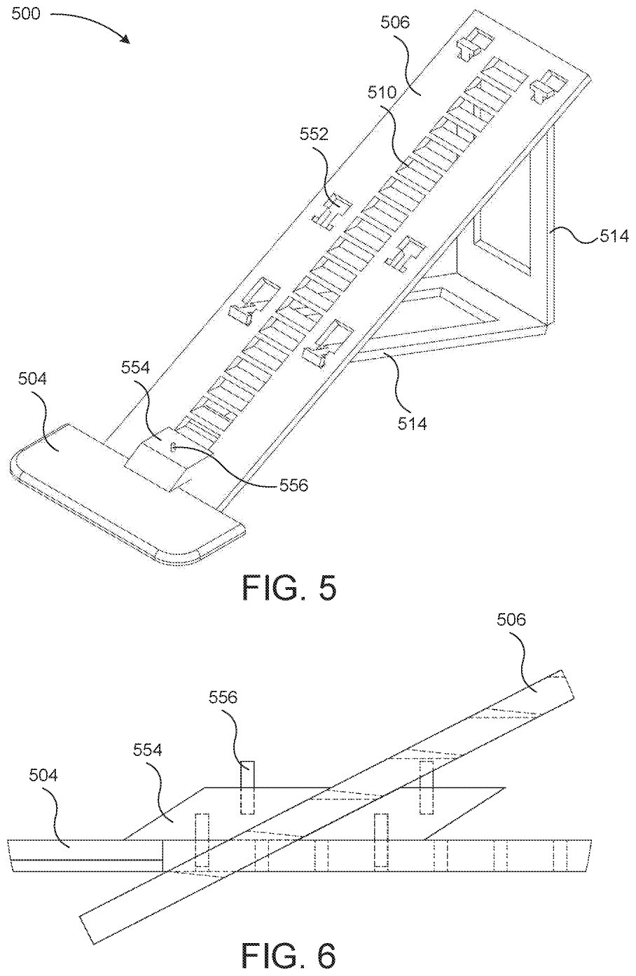

FIGS. 5 and 6 depict another embodiment of a portable stair apparatus 500. The apparatus 500 is depicted in perspective with a single step 504 in FIG. 5, for convenience in viewing a riser 506 and legs 514. FIG. 6 depicts a detailed side view of a step 504 coupled to the riser 506

In the depicted embodiment, the support structure includes a riser 506, with a plurality of openings 510. A step 504 includes a tongue that may be inserted through an opening 510. The support structure includes a pair of legs hinged together. The legs 514 may be positioned to engage different openings 552 in the riser 506. Thus, adjusting the position of the legs 514 adjusts the angle and height of the riser 506. Means for adjusting the angle of the riser may include the legs 514 and/or openings 552 for engaging the legs 514.

As depicted in FIG. 6, openings 510 may permit insertion of a step 504 at various angles and/or depths. A block 554 may be used to wedge a step 504 into an opening 510 at a selected position. In certain embodiments, pins 556 may secure the block 554 to the step 504, or within the opening 510. Thus, in the depicted embodiment, means for independent, per-step adjustment of step positions may include openings 510, blocks 554, and/or pins 556.

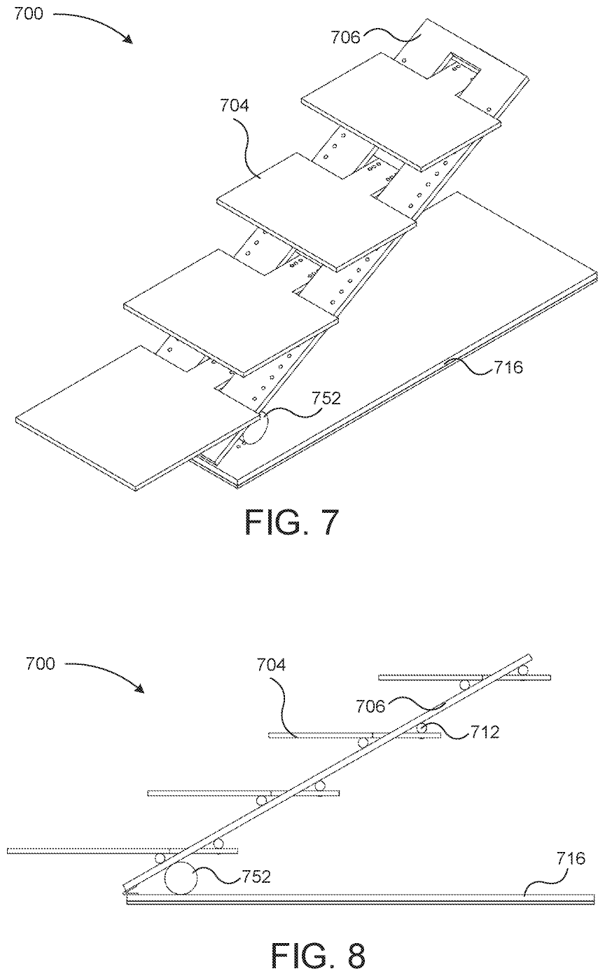

FIGS. 7 and 8 depict another embodiment of a portable stair apparatus 700, in a perspective view and a side view. In the depicted embodiment, the support structure includes a base 716 and a riser 706, as described above. Steps 704 include tongue and tread areas and are coupled to the riser 706 using dowels 712, as described above

In certain embodiments, a portable stair apparatus may include a set of removable steps 704 of varying sizes. The plurality of steps 704 coupled to the support structure (e.g., to the riser 706) may be selected from the larger set of removable steps. For example, in the depicted apparatus, four steps 704 coupled to the riser 706 have been selected by a user from a larger set of steps. Providing a set of removable steps 704 of varying sizes may allow a user to adjust a portable stair apparatus to better accommodate a pet's needs. The steps 704 that are coupled to the riser may be of non-uniform size, and may include varying side to side widths, varying front-to-back tread depths, or the like. For example, in FIGS. 7 and 8, the lowest step has a deeper tread depth (from front to back) than the other steps.

In some embodiments, a user may adjust the number of steps 704 that are coupled to the support structure (e.g., the riser 706). For example, for the same slope and height, a user may use a larger number of shorter-depth steps to accommodate the needs of a smaller pet, or may use a smaller number of longer-depth steps to accommodate the needs of a larger pet.

Similarly, in some embodiments, a user may adjust individual step positions, including step heights, so that vertical distances between pairs of steps are non-uniform. Staggered or non-uniform step heights may accommodate the needs of certain pets in ways that uniform step heights do not.

In the depicted embodiment, the bottom end of the riser 706 is coupled to the base 716 at a hinge, and a wedge or block 752 supports the riser 706 above the base 716, and acts as a means for adjusting the angle of the riser 706. The block 752 may be coupled to the base 716 by pins or the like, and may be adjusted laterally on the base 716 to decrease or increase the angle of the riser 706. Thus, in the depicted embodiment, a means for adjusting the angle of the riser 706 includes the block 752.

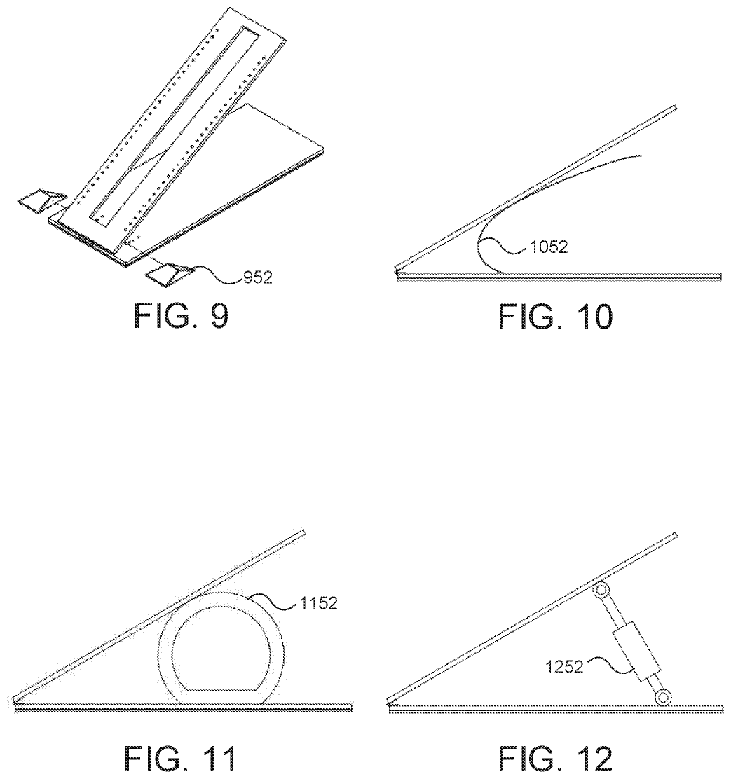

FIGS. 9-11 depict further embodiments of means for riser angle adjustment. In FIG. 9, a means for riser angle adjustment includes a wedge 952 that supports a riser above a base. In one embodiment, a plurality of wedges may support adjusting the riser to different angles. In the depicted embodiment, the wedge 952 is formed with different angles between different pairs of surfaces, so the same wedge 952 may be turned to a different orientation to support the riser at different angles. In another embodiment, a two-piece wedge may support the riser at different angles depending on whether both pieces are used, and/or on the orientation of either or both pieces.

In FIG. 10, a means for riser angle adjustment includes a spring 1052 that supports a riser above a base. The position of the spring 1052 may be laterally adjusted to adjust the angle of the riser, or the spring 1052 may be bent to a different position. In addition, a spring 1052 may provide some give to steps that might otherwise be rigidly positioned.

In FIG. 11, a means for riser angle adjustment includes a block 1152 that supports a riser above a base. The block 1152 is larger and further from the intersection of the riser and base than the block 752 of FIG. 7. A larger block 1152 may provide a different feel or a different amount of give than a smaller block 752.

FIG. 12 depicts a shock absorber 1252 for a riser. A shock absorber 1252 may be used in conjunction with a component such as a block 752 1152, wedge 952 or spring 1052 that supports a riser, and may provide dampening to soften the impact of a footstep. In another embodiment, treads of steps may include a shock absorbing material, or a support of a riser, such as a block 752, may include a shock absorbing material. Shock absorption may ease the impact to animal joints during the climbing or descending process.

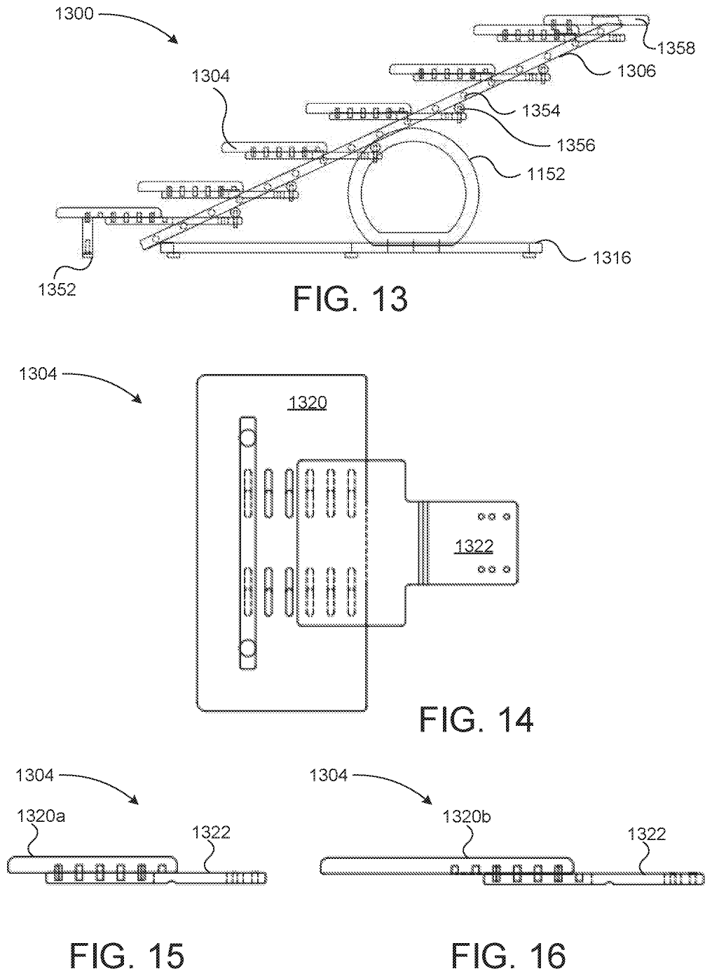

FIG. 13 depicts another embodiment of a portable stair apparatus 1300, in a side view. In the depicted embodiment, the support structure includes a riser 1306 and a base 1316 as described above, and a block 1152 as described above with reference to FIG. 11. In the depicted embodiment, dowels 1354 extend across an opening which may be similar to the opening 110 of FIG. 1, forming slots that may be used as attachment points for steps 1304. Pins 1356 may be disposed in different holes in the tongue area of the steps 1304, to level the steps 1304 or adjust the step angle. A front support 1352 may be coupled to a step 1304 to support the step above the ground or floor, or above a previous step 1304. For example, in the depicted embodiment, a front support 1352 supports the lowest step 1304 above the ground. In some embodiments, a front support 1352 may support a higher step 1304 above the adjacent lower step.

A landing 1358 is provided at the upper level. In some embodiments, an upper landing 1358 may cover the top end of a riser, making it convenient for a pet to step from the landing 1358 onto another surface. In another embodiment, a landing 1358 may not cover the top end of a riser 1306, but may be provided at another level, and the landing 1358 may be similar to an enlarged step. In some embodiments, a landing 1358 may provide space for a stair user, such as a pet, to turn, or to enter or exit the portable stair apparatus 1300. For example, where a portable stair apparatus 1300 ascends next to a couch, a landing 1300 may allow a pet to move from the top step area around to the front of the couch to enter or exit the apparatus 1300 there. Other embodiments of landings are described below with reference to other Figures.

FIGS. 14-16 depict further details of the steps 1304, in top and side views. In FIG. 14, the tread area 1320 and the tongue area 1322 of a step 1304 are separate components (Conversely, in FIG. 1, a step 104 is formed as a single piece). Protrusions and slots allow for the tread area 1320 to be adjusted relative to the tongue area 1322, or to be replaced with a different (e.g., larger or smaller) tread area.

For example, in FIG. 15, the tread area 1320a is shorter than the tread area 1320b in FIG. 16, and is at a position of minimum extension from the tongue area 1322. In FIG. 16, the shorter tread area 1320a of FIG. 15 is replaced with a longer tread area 1320b, at a position of greater extension from the tongue area 1322. Tread areas 1320 may also be adjusted laterally with regard to the tongue areas 1320 in embodiments where (as in FIG. 15), slots are wider than protrusions. Thus, a means for adjusting step position may include replaceable tread areas 1320, slots and protrusions for adjusting tread areas 1320 relative to tongue areas 1322, holes in the tongue area 1322 for angle adjustment pins 1352, or the like.

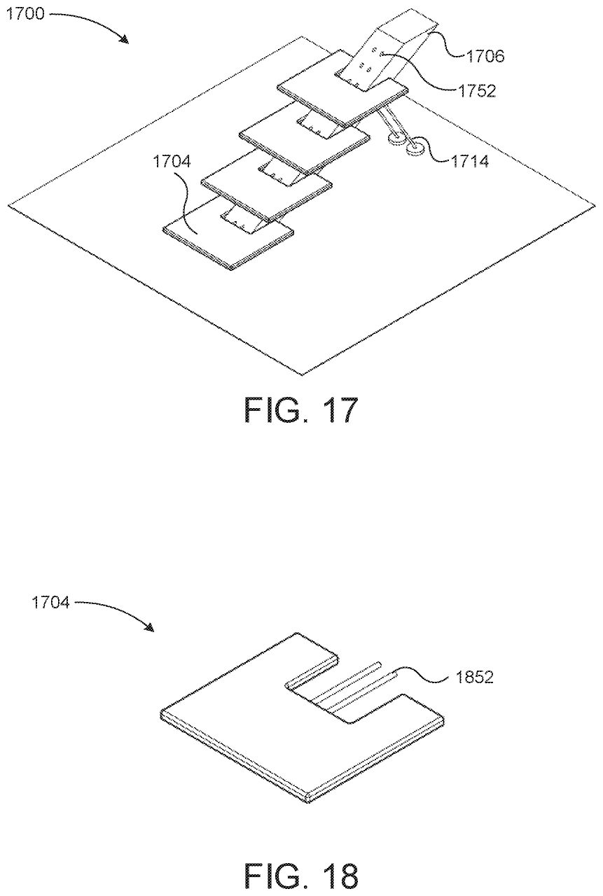

FIG. 17 illustrates another embodiment of a portable stair apparatus 1700, and FIG. 18 illustrates one embodiment of a step 1704 for use with the apparatus 1700. In the depicted embodiment, the riser 1706 is an inclined or diagonal stick or post. Legs 1714 are depicted to support the riser 1706, but in another embodiment, a riser 1706 may be supported at the lower level (e.g., at the ground or floor) and at the upper level (e.g., at a car, truck, or piece of furniture) without legs 1714, or may be supported in another way. The steps 1704 include one or more prongs 1852 (which may include a pair of prongs 1852 as in FIG. 18, or which may include more or fewer than two prongs). The riser 1706 includes a plurality of holes 1752 to admit the prongs. In the depicted embodiment, with fixed holes, the step angle relative to the riser 1706 is fixed, and the riser angle is fixed if steps 1704 are to remain level. Nevertheless, the holes 1752 and prongs 1852 may act as means for independent adjustment of step height and horizontal position

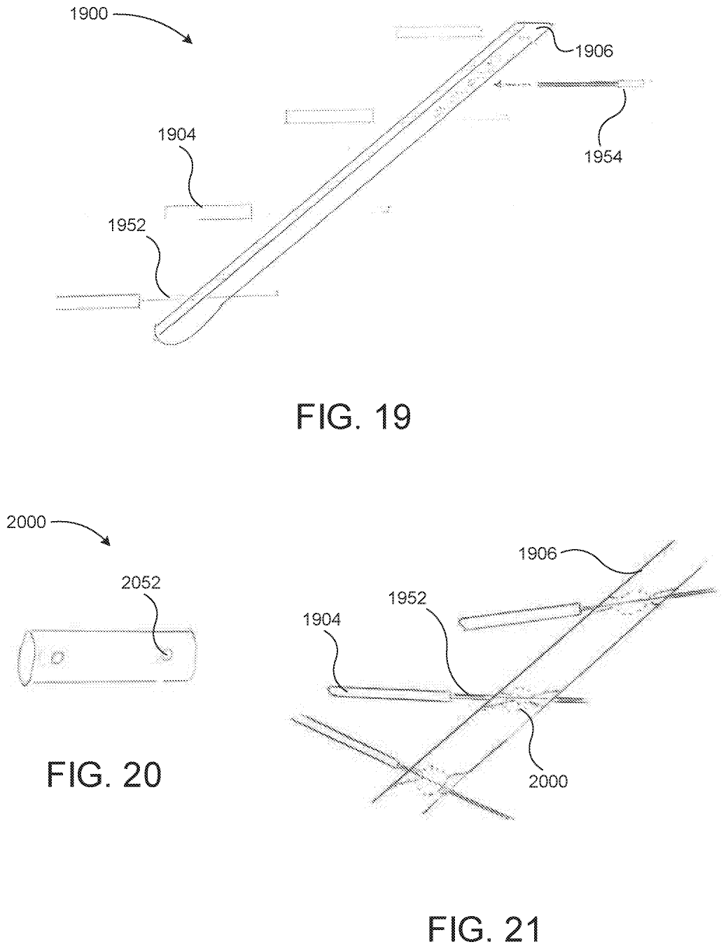

FIGS. 19-21 depict another embodiment of a portable stair apparatus 1900, with the riser 1906 as an inclined or diagonal stick or post as in FIG. 17, and where steps 1904 with prongs 1952 engage holes 2052 in the riser 1906. In the depicted embodiment, a brace 1954 is similar to the steps, including a surface and prongs to engage holes 2052, but the brace 1954 extends backwards from the riser 1906 to support the riser 1906 on a surface such as a bed, couch, car, or truck.

Additionally, unlike in the apparatus 1700, the holes 2052 in the apparatus 1900 are pivotable relative to the riser 1906, allowing step angle adjustments. The holes 2052 are formed in a round dowel 2000, as shown in FIG. 20, and similar round dowels 2000 with holes 2052 are disposed in the riser 1906 at step attachment points. Holes in the riser 1906 may be wider than holes 2052 in the round dowels 2000 to accommodate a plurality of step angles. Steps 1904 and round dowels 2000 may be adjusted to desired angular positions, and locked into angular positions by locking mechanisms at the sides of the round dowels 2000, wedges below the front of a step 1904 and/or above the back of a step 1904, dowels as in FIG. 1, or the like. With step angles adjustable, the angle of the riser 1906 may also be adjusted. Thus, in FIG. 19, the riser 1906 has a rounded bottom to support the riser 1906 at various angles

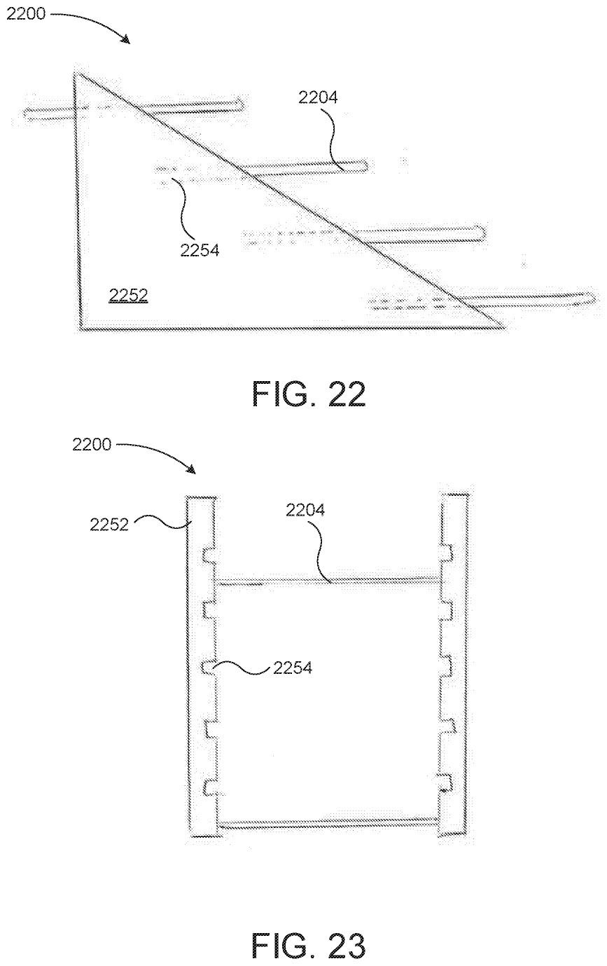

FIGS. 22 and 23 illustrates another embodiment of a portable stair apparatus 2200, in side and front views. Unlike the previously described apparatuses, the portable stair apparatus 2200 does not include a diagonal riser. Rather, in the depicted embodiment, the support structure includes a pair of vertical sidewalls 2252, with slots 2254 in the side walls at a plurality of step heights, for admitting the steps 2204 (e.g., as attachment points for steps 2204). Steps may be inserted or removed into slots 2254 to adjust the number of steps, and may be inserted into slots 2254 at different heights or depths. For example, steps 2204 at the same heights may be adjusted to different depths in the slots 2254 to provide a steeper or shallower slope. Thus, the slots 2254 may act as means for adjusting step positions.

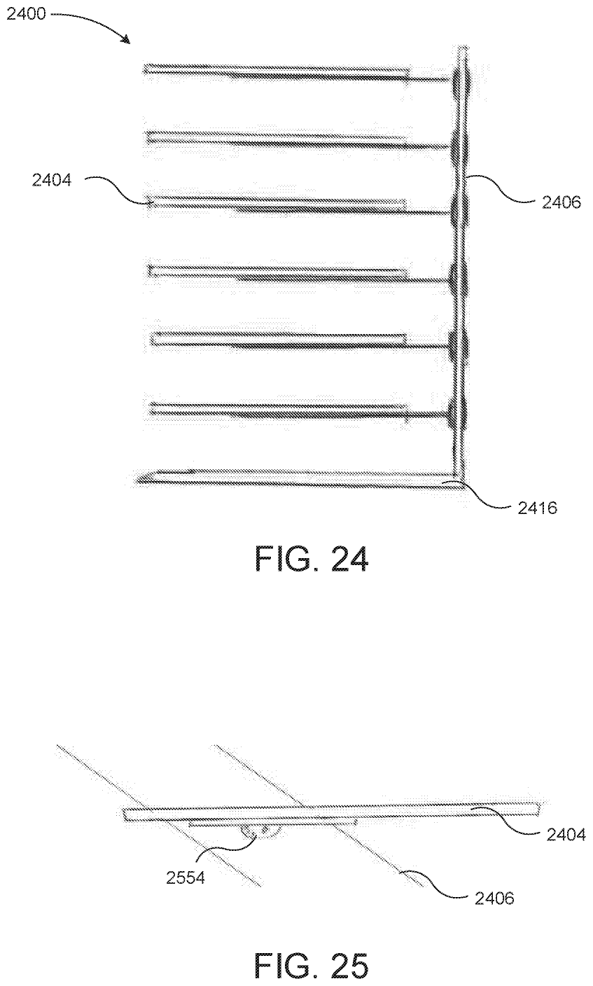

FIG. 24 depicts a front view of another embodiment of a portable stair apparatus 2400. In the depicted embodiment, the support structure includes a diagonal riser 2406 at one side of the apparatus 2400. Sides of “floating” steps 2404 (which may be unsupported at an opposite side) are coupled to the riser 2406. In the depicted embodiment, the riser 2406 is coupled to a heavy base 2416. In a non-portable or less-portable embodiment, the riser 2406 may be coupled to a wall rather than to a portable base 2416.

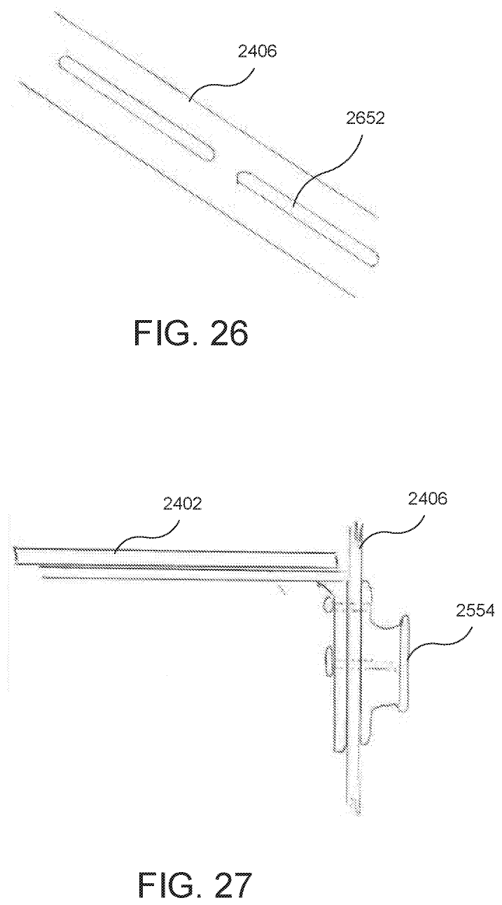

FIG. 25 depicts the step 2404 coupled to the riser 2406 of FIG. 24 in a further embodiment, from a side view looking from the unsupported side of a step 2404 toward the riser 2406. A mechanism 2554 for coupling the step 2404 to the riser 2406 may be pivotable, allowing adjustment of step angles. FIG. 26 depicts the riser 2406 without steps 2404 attached. Holes 2652 in the riser 2406 permit the mechanism 2554 of FIG. 25 to slide up and down the riser 2406. Thus, a hole 2652 provides a continuum of step attachment points, and the mechanism 2554 and the hole 2652 act as a means for step position adjustment.

FIG. 27 depicts a front view of the riser 2406, step 2404 and mechanism 2554. The mechanism 2554 clamps to both sides of the riser 2406, and the angle or height adjustment provided by the mechanism 2554 may be locked in by tightening the mechanism 2554 (e.g., adjusting one or more fasteners to clamp the mechanism 2554 across the riser 2406 with greater force)

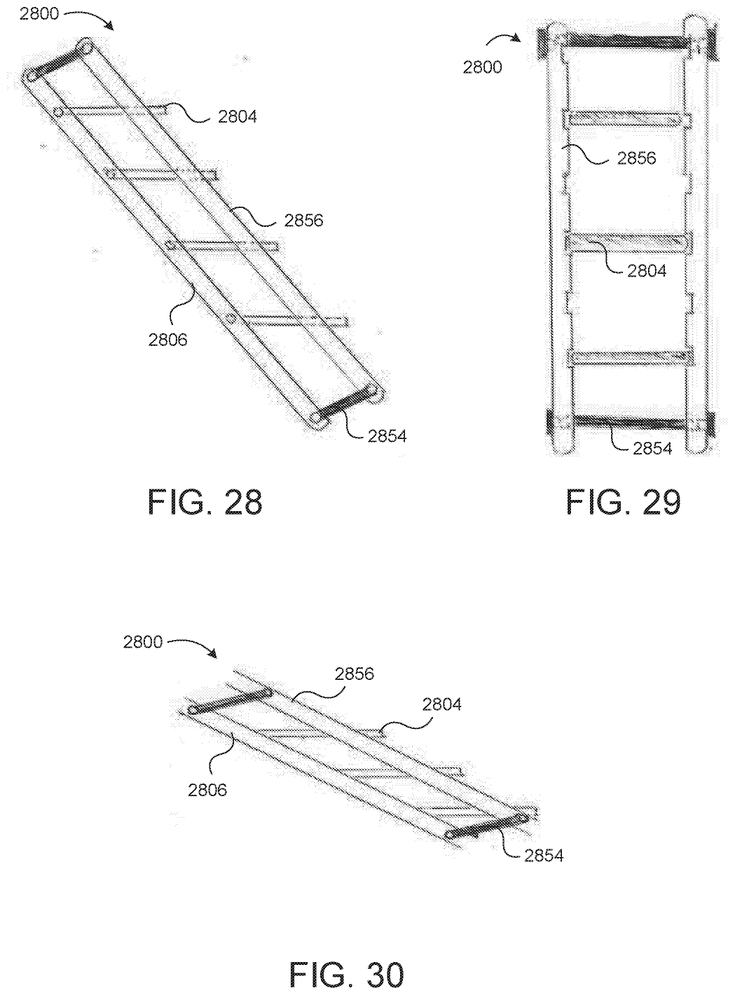

FIGS. 28-30 depict another embodiment of a portable stair apparatus 2800, in a side view, a front view, and another side view with different riser angles. In the depicted embodiment, the support structure includes base risers 2806, floating risers 2856, and a linkage 2854 coupling the base risers 2806 and the floating risers 2856. At each side of the apparatus 2800, the linkage 2855 couples the top and bottom of a base riser 2806 and a floating riser 2856, keeping the floating riser 2856 parallel to the base riser 2806. The linkage 2854 also couples risers 2806, 2856 across opposite sides of the apparatus, as seen in FIG. 29 (where the floating risers 2856 are visible in front, obscuring the base risers 2806 in back). The linkage 2854 acts a means to adjust the riser angle and total height.

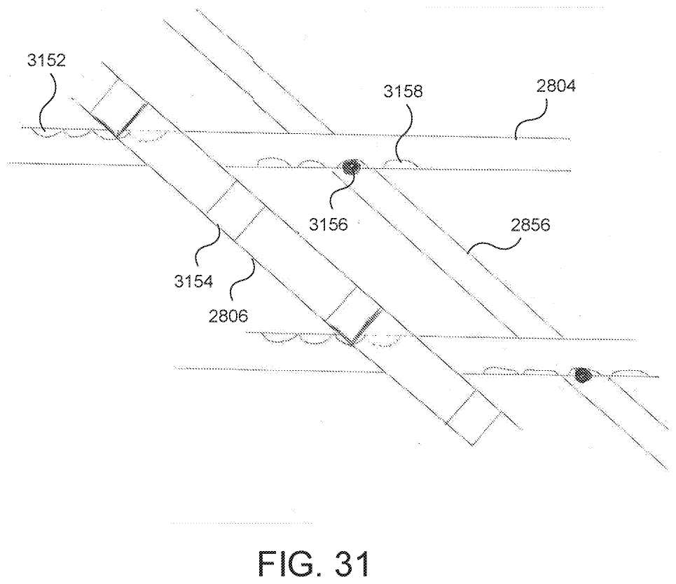

However, unlike stairs that provide adjustment of the total height with parallelogram linkages to uniformly adjust step positions, the steps 2804 in the depicted embodiment are not coupled to parallelogram linkages, but are independently adjustable. FIG. 31 depicts a detailed view of a step 2804 coupled to a base riser 2806 and a floating riser 2856. The base riser 2806 may include protrusions 3154 to engage indentations 3152 in upper surfaces of the steps 2804. The floating riser 2856 may include protrusions 3156 to engage indentations 3158 in lower surfaces of the steps 2804. Protrusions 3154, 3156 and/or indentations 3152, 3158 may allow steps 2804 to be adjusted in height, or to be angled or leveled independently of the angle of the base riser 2806 and floating riser 2856. Thus protrusions 3154, 3156 and or indentations 3152, 3158 may act as means for independent step position adjustment.

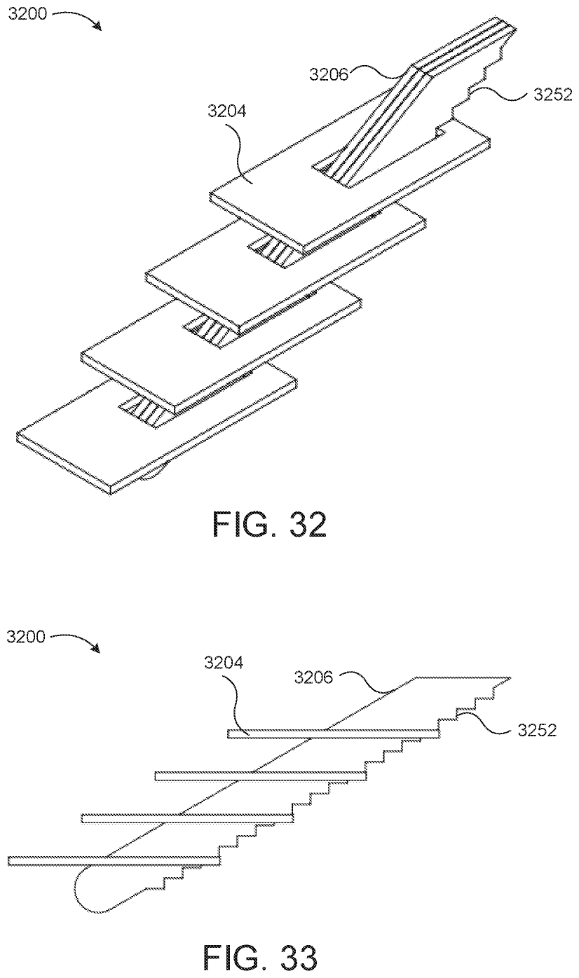

FIGS. 32 and 33 is a perspective view illustrating another embodiment of a portable stair apparatus 3200, in a perspective view and a side view. In the depicted embodiment, the support structure includes a diagonal riser 3206 with a toothed lower surface 3252. Steps 3204 wrap at least partially around the riser 3206, so that the front of a step 3204 rests on the riser 3206 and the back of the step 3204 rests in (or is held down by) an indentation in the toothed lower surface 3252. In the depicted embodiment, steps 3204 wrap around the riser 3206. A step 3204 may be tilted up to move the step 3204 to a different height, and may be tilted back to a level position to hold the step 3204 at a selected height. In another embodiment, steps 3204 may include one or more removable pin at the back, and may be adjusted in height by removing and replacing the pin(s).

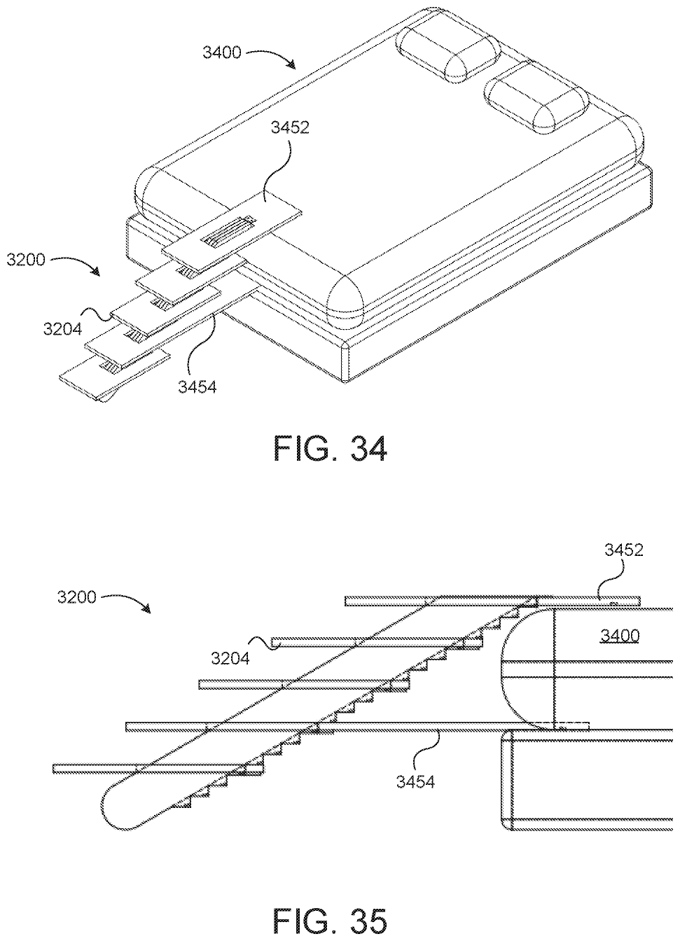

In some embodiments, an apparatus 3200 may be supported by legs, furniture, a vehicle, or the like, as described above. FIGS. 34 and 35 depict perspective and side views of the apparatus 3200 resting on a bed 3400, in one embodiment. In the depicted embodiment, the apparatus 3200 includes a landing 3452 and an extension member 3454.

In various embodiments, one or more landings 3452 may be coupled to the support structure for a portable stair apparatus. In some embodiments, a landing 3452 may extend onto a surface of a piece of furniture (e.g., a bed, a couch, a car seat, or the like), at the upper level of the apparatus. For example, in the depicted embodiment, a landing 3452 extends backwards from a top step 3204, allowing a pet to conveniently transition between the portable stair apparatus 3200 and the bed 3400 (or another piece of furniture).

An extension member 3454, in various embodiments may extend from the support structure and/or from a step 3204, and may be insertable in a horizontal gap in a piece of furniture to stabilize the apparatus. For example, in the depicted embodiment, the extension member 3454 extends from a step 3204, and is inserted into a gap in the bed 3400, between the mattress and box springs. Similarly, in another embodiment, an extension member 3454 may be anchored under a couch cushion. In some embodiments, a base or bottom step may similarly be extended to be anchored under a couch, a bed, or another item.

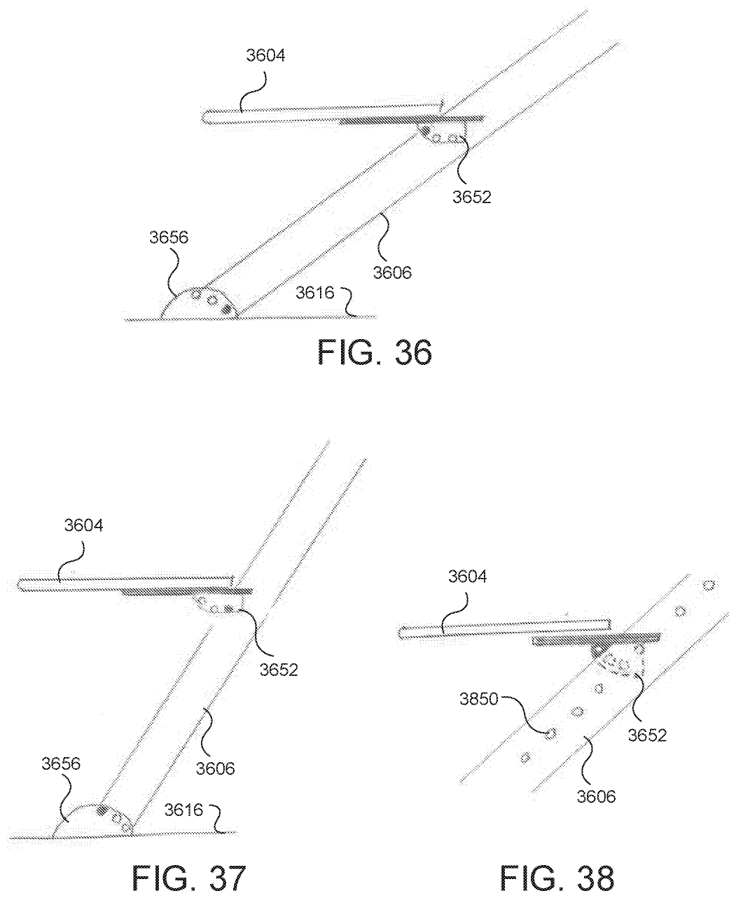

FIGS. 36, 37, and 38 depict side views of a step 3604 and riser 3606, in another embodiment of a portable stair apparatus. In the depicted embodiment, a means for adjusting the riser angle includes a pin and plate mechanism 3656 coupling the riser 3606 to a base 3616, and a means for adjusting a step position includes a pin and plate mechanism 3652 coupling the step 3604 to the riser. A pin and plate mechanism 3652, 3656 includes a pivot point, a plate with holes, and a pin that is selectively engageable in the holes to lock the mechanism 3652, 3654 at a selected angle. Thus, in certain embodiments, the riser angle may be adjusted using a pin and plate mechanism 3656 for the riser 3606, and individual step positions may be adjusted using individual pin and plate mechanism 3652 for the steps 3604.

Additionally, in some embodiments, the pin and place mechanism 3652 for a step 3604 may provide a height adjustment for the step 3604. FIG. 38 depicts holes 3850 in the riser 3606. A pivot pin in the pin and plate mechanism 3652 may be selectively engageable with the holes 3850, allowing the step 3604 to be adjusted up and down the riser 3606 to different step attachment points.

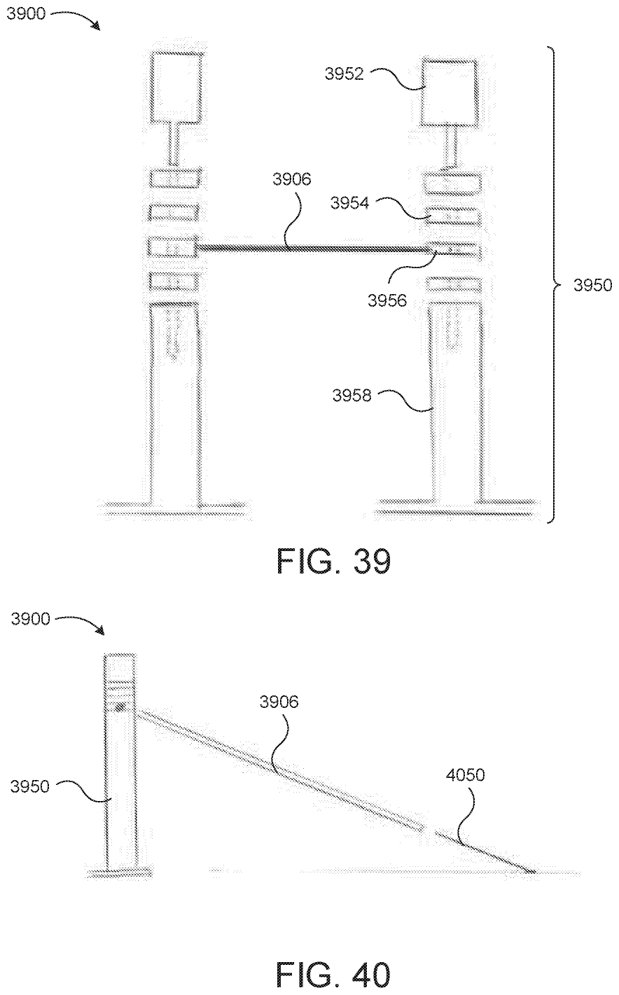

FIGS. 39 and 40 depict front and side views of another embodiment of a portable stair apparatus 3900. In the depicted embodiment, a support structure includes a diagonal riser 3906 supported at an upper end by posts 3950. Steps are not depicted in FIGS. 39 and 40 for convenience in depicting and describing the riser 3906 and posts 3950, but may be coupled to the riser 3906 in various was as described herein with reference to other Figures.

FIG. 39 depicts the posts 3950 in an exploded view, as indicated by a bracket. In the depicted embodiment, a post 3950 includes a base 3958, a riser attachment point 3956, one or more spacers 3954, and a cap 3952. The cap 3952 includes a prong to fasten the spacers 3954 and the riser attachment point 3956 to the base 3958. A user may remove the cap 3952 to adjust the number of spacers 3954, or the order of spacers 3954 relative to the riser attachment point 3956. Thus, the post 3950 including spacers 3954 may act as a means for adjusting the riser height and angle. Other or further ways of fastening a riser 3906 to posts 3950 at variable heights or angles may be used in other or further embodiments.

As shown in FIG. 40, the riser 3906 may extend between the ground or another surface at the lower level and the attachment points 3956 of the posts 3950 at the upper level. In certain embodiments, one or more riser extensions 4050 may be capable of extending from a riser 3906 (or from multiple risers in multiple-riser embodiments) to increase a height or length of the support structure for an apparatus. In the depicted embodiment, a riser extension 4050 extends from the bottom end of the riser 3906, increasing the riser length with a fixed height and a decreased angle. In another embodiment, a riser extension 4050 may extend from the bottom or top end of a riser 3906, providing increased riser height at a fixed angle. In various embodiments, a riser extension 4050 may be coupled to a riser 3906 via a hinge to fold out for use, may be an insert that extends from or retracts into a hollow in the riser 3906, or may be a separate piece attachable and detachable via a sleeve, an insert, a bracket, or the like.

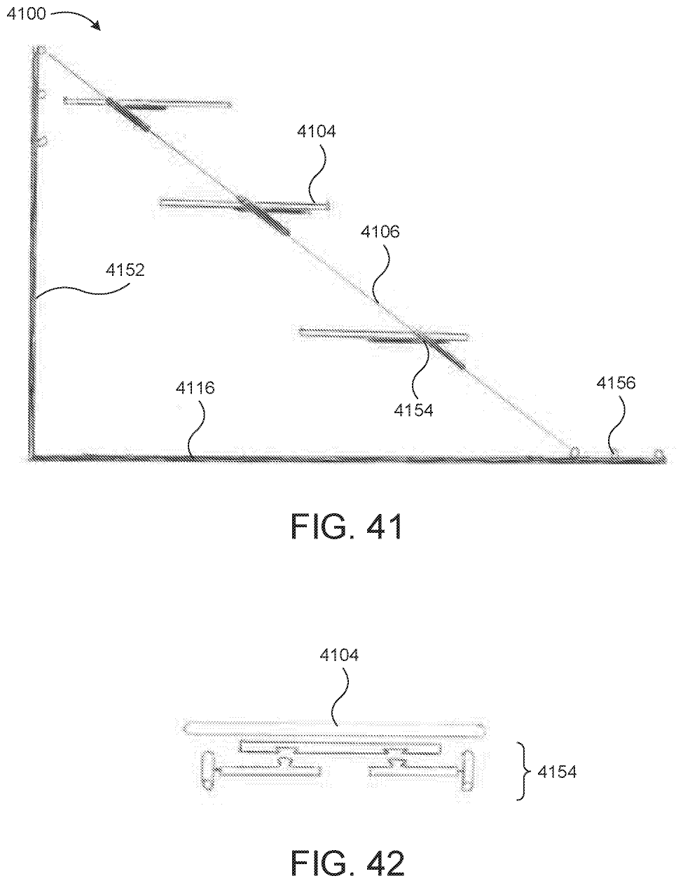

FIG. 41 depicts another embodiment of a portable stair apparatus 4100, in a side view. FIG. 42 depicts detail of a step 4104 and a bracket 4154 for coupling the step 4104 to a riser 4106 position. In the depicted embodiment, the support structure includes a base 4116, a vertical member 4152 extending up from the back of the base 4116, and a diagonal riser 4106. Additionally, the diagonal riser 4106 is not a rigid structure such as wood or metal, but is a wire or cable under tension between two attachment points 4156 on the base 4116 and the vertical member 4152. In another embodiment, a riser 4106 may be a rod or a similar rigid component extending between attachment points 4156. Multiple attachment points 4156 may be provided on the base 4116 and the vertical member 4152 as means for adjusting the angle of the riser 4106.

The bracket 4154, in the depicted embodiment, includes clamps for coupling the step 4104 to the riser 4106. Step support components extent horizontally from the clamps to support the step, and are pivotable relative to the step. Dovetails or other sliding joints allow lateral adjustment of the tread. Thus, the bracket 4154 may be a means for independent adjustment of a step position.

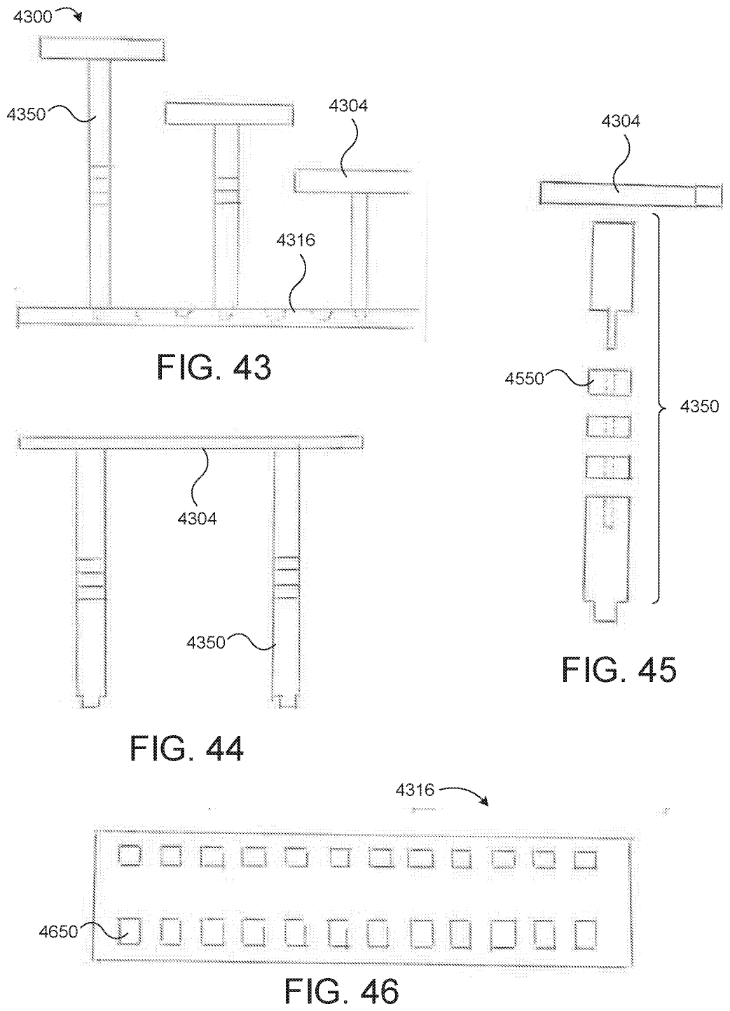

FIG. 43 depicts another embodiment of a portable stair apparatus 4300, in a side view. In the depicted embodiment, the support structure includes a base 4316 and a plurality of posts 4350 coupled to the base 4316. Steps 4306 are coupled to the tops of the posts 4350. FIG. 44 depicts a front view of a step 4306 supported by a pair of posts 4350. FIG. 45 depicts an exploded view of a post 4350. Spacers 4550 may be selectably inserted or removed by a user to adjust the height of the post. FIG. 46 depicts a top view of the base 4316. Posts 4350 may be selectably disposed in openings 4650 in the base 4316. Thus, position of a step 4304 may be vertically adjustable by adding or removing spacers 4550 to a post 4350, and may be horizontally adjustably by disposing posts 4350 in different openings 4650.

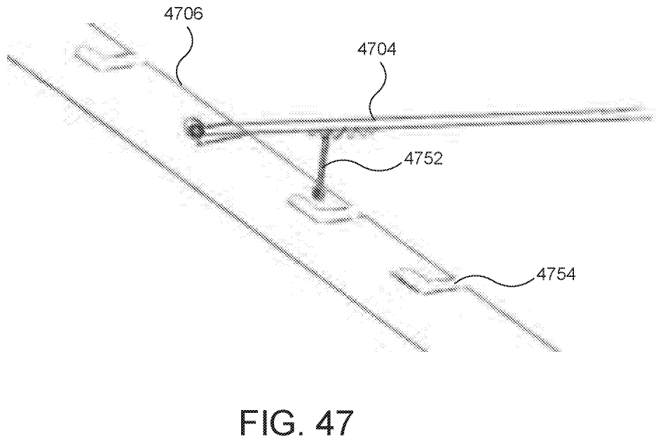

FIG. 47 depicts a step 4704 coupled to a riser 4706, in one embodiment. In the depicted embodiment the riser 4706 includes a plurality of openings 4754 at step attachment points. The step 4704, or a pin protruding from the step 4704, may be inserted in an opening 4754 at a selected step height. An under-step support 4752 may extend between the step 4704 and the riser 4706 to support the step 4704. In the depicted embodiment, the under-step support 4752 pivots from the riser 4706 to engage indentations on the step 4704. In another embodiment, an under-step support 4752 may pivot from the step 4704 to engage an indentation on the riser 4706. An under-step support 4752 may support a step 4704, and may be repositionable to adjust an angle of the step 4704. Thus, the openings 4754 and the under-step support 4752 act as means for independent adjustment of the step positions.

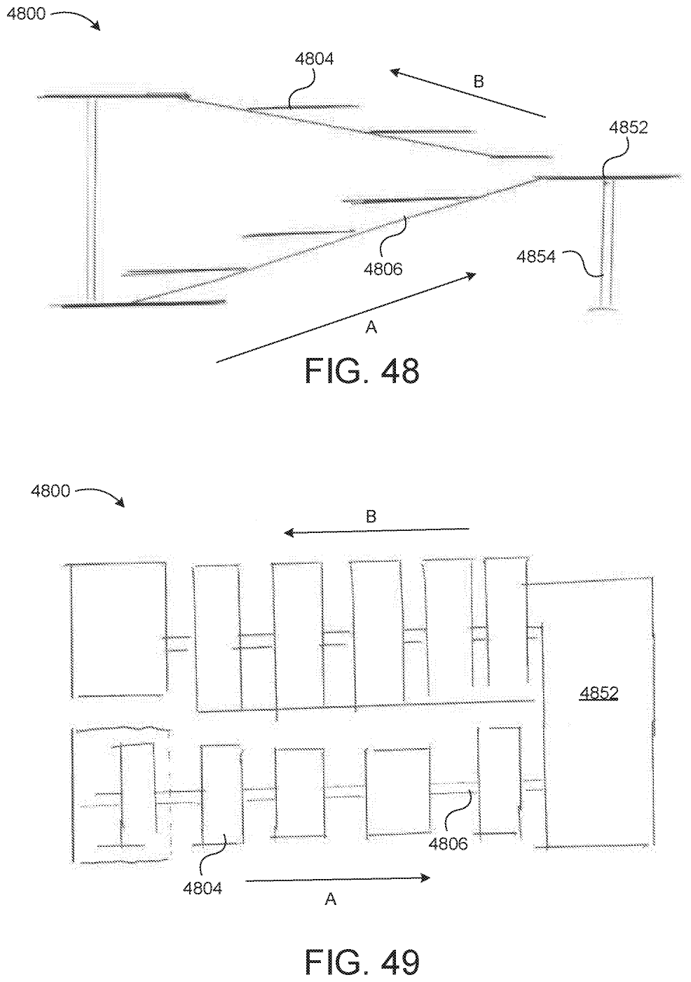

FIGS. 48 and 49 depict another embodiment of a portable stair apparatus 4800, in a side view and a top view. In the depicted embodiment, the support structure includes posts 4854 and risers 4806. Steps 4804 are coupled to the risers 4806 and/or posts 4854. A landing 4852 is coupled to the support structure. The steps 4804 ascend in a first direction (indicated by arrow A) from the lower level to the landing 4852, and in a second direction (indicated by arrow B) from the landing 4852 to the upper level. The second direction is different from the first direction. In the depicted embodiment, the second direction is opposite to the first direction. In another embodiment, the second direction may be at right angles to the first direction, or may be another direction at another angle from the first direction. In certain embodiment, steps 4804 that ascend in two different directions may allow a portable stair apparatus 4800 to fit in a small space without a steep slope that may be unsuitable for pets. Providing a landing 4852 where the direction changes may give a pet space to comfortably change direction.

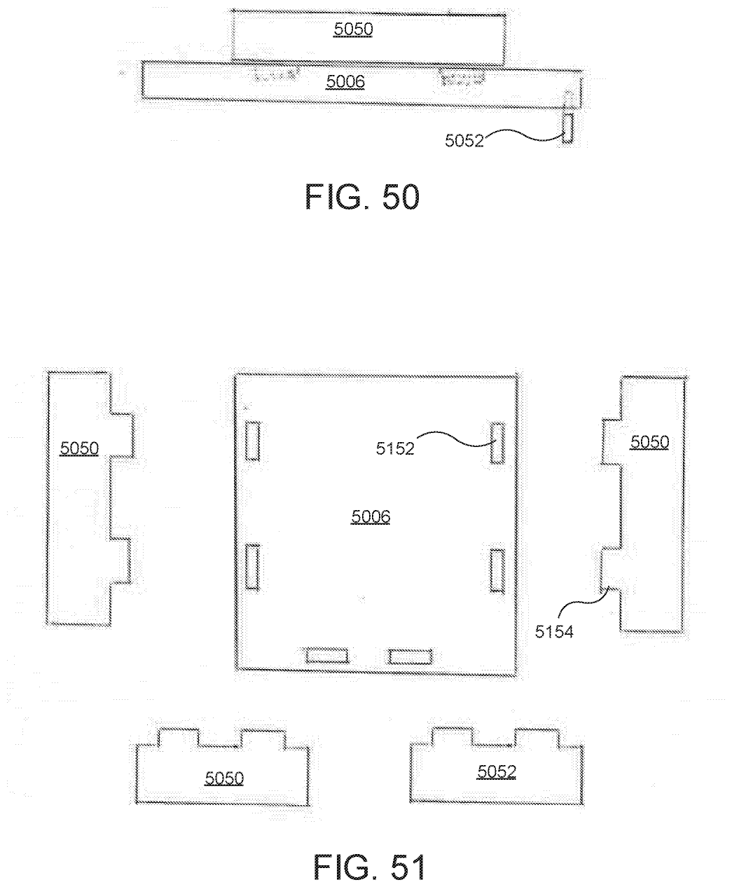

FIGS. 50 and 51 depict a step S006 with removable walls 5050 and an under-step support 5052. The step S006, walls 5050, and under-step support 5052 are depicted assembled, in a side view, in FIG. 50, and are depicted disassembled, in a top view, in FIG. 51. Providing walls 5050 for steps S006 may provide visual safety and guidance for a pet using a portable stair apparatus. Protrusions 5154 from removable side and/or front walls 5050 may slot into holes 5152 in the step 5006. An under-step support 5052 may similarly slot into holes in the underside of the step 5006. An under-step support 5052 may support the edge of the step 5006, and may in turn be supported by a riser, a lower step, a floor, or, the ground.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A portable stair apparatus comprising:
a support structure extending from a lower level to an upper level;
a plurality of steps coupled to the support structure; and
means for independent, per-step adjustment of step positions relative to the support structure.

2. The apparatus of claim 1, wherein the support structure comprises one or more risers extending diagonally from the lower level to the upper level.

3. The apparatus of claim 2, wherein the support structure further comprises a base coupled to the one or more risers.

4. The apparatus of claim 2, further comprising means for adjusting an angle of the one or more risers.

5. The apparatus of claim 2, wherein the steps each comprise a tread area and a tongue area narrower than the tread area, and a riser comprises one or more openings to admit the tongue areas of the steps.

6. The apparatus of claim 2, wherein the steps each comprise one or more prongs, and a riser comprises a plurality of holes to admit the prongs.

7. The apparatus of claim 2, wherein the means for independent, per-step adjustment of step positions comprises a plurality of step attachment points provided by the one or more risers.

8. The apparatus of claim 2, further comprising one or more riser extensions capable of extending from the one or more risers to increase a height of the support structure.

9. The apparatus of claim 1 wherein the means for independent, per-step adjustment of step positions permits adjustment of step angle, step rise, horizontal step position, or combinations thereof

10. The apparatus of claim 1, further comprising a set of removable steps of varying sizes, wherein the plurality of steps coupled to the support structure are selected from the set of removable steps.

11. The apparatus of claim 1 wherein the plurality of steps are of non-uniform size.

12. The apparatus of claim 1, wherein vertical distances between pairs of steps are non-uniform.

13. The apparatus of claim 1, wherein the support structure comprises slots at a plurality of step heights, for admitting the steps.

14. The apparatus of claim 1, further comprising one or more landings coupled to the support structure.

15. The apparatus of claim 14, wherein the plurality of steps ascends in a first direction from the lower level to a landing, and ascends in a second direction from the landing to the upper level, the second direction different from the first direction.

16. The apparatus of claim 14, wherein a landing extends onto a surface of a piece of furniture, at the upper level.

17. The apparatus of claim 1, further comprising an extension member that extends from the support structure or from a step, the extension member insertable in a horizontal gap in a piece of furniture to stabilize the apparatus.

18. A portable stair system comprising:
a support structure configured to extend from a lower level to an upper level;
a plurality of steps selectively attachable to the support structure at a plurality of adjustable step heights.

19. The system of claim 18, wherein the support structure comprises a riser configured to extend diagonally from the lower level to the upper level, and one or more legs for supporting the riser, wherein a position of the legs is adjustable for adjusting the angle and height of the riser.

20. A portable stair apparatus comprising
a support structure extending from a lower level to an upper level, the support structure comprising a base, a riser coupled to the base and extending diagonally from the lower level to the upper level, and one or more legs for supporting the riser, wherein a position of the legs is adjustable for adjusting the angle and height of the riser;
a plurality of step attachment points formed in the riser for attaching steps at a plurality of adjustable step heights
a plurality of steps coupled to the support structure, wherein the steps each comprise a tread area and a tongue area narrower than the tread area, and the step attachment points comprise one or more openings to admit the tongue areas of the steps.
